(19) United States
(12) Patent Application Publication
(10) Pub. No.: US 2005/0115686 A1
(43) Pub. Date: Jun. 2, 2005

(54) Foldable plates-system, useful as a window or a shutter

(75) Inventor: Hagai Yedidya, Kiryat-Ata (IL)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: ROLLTEC EUROPE, Jerusalem (IL)

(21) Appl. No.: 10/500,607

(22) PCT Filed: Dec. 29, 2002
(86) PCT No.: PCT/IL02/01051

(30) Foreign Application Priority Data
Jan. 2, 2002 (IL) 147439

(51) Int. Cl. E05D 15/16

(52) U.S. Cl. 160/202

(57) ABSTRACT

The invention relates to a system made of plates-string capable to be folded by pushing the first plate (10) of said plates-string while the last (12) plate is blocked and capable to be unfolded by pulling the first plate (10) of said plates-string while the last plate (12) is blocked. Windows, or shutters, made of wings string that is capable to be folded into a small case or to be unfolded from is also disclosed. The invention additionally relates to a method for folding and unfolding wings of a window or a shutter.

### FIELD OF THE INVENTION

The present invention relates to a plate-system that is capable to be folded or to be unfolded and a method wherein the plate-system can be of use. More specifically, the present invention relates to windows, or shutters, made of wings string that is capable to be folded into a small case or to be unfolded from.

### BACKGROUND OF THE INVENTION

Various systems and apparatuses for closing passages and windows or for surface covering are known, including wing windows, roll-up blinds, roller shades and others. These designs are particularly disadvantageous in that they are complicated, have a lack of sealing, and require a large space for opened wings or for rolled slats. Moreover, roll-up blinds need thick cases to be rolled into and moving windows need tracks for each wing one beside the other, which make the windows look clumsy.

There is therefore a recognized need for, and it would be highly advantageous to have, a foldable plates-system that is useful as a window or a shutter that is simple, saves space, provides better sealing and inexpensive relative to known systems.

### SUMMARY OF THE INVENTION

The present invention is a foldable plates-system that is useful as a window or a shutter.

According to the teachings of the present invention there is provided a system that is made of plates-string capable to be folded by pushing the first plate of the plates-string while the last plate is blocked and capable to be unfolded by pulling the first plate of the plates-string while the last plate is blocked, wherein the system is comprised of:
a plurality of plates arranged in a plates-string column, wherein two side-edges of each plate are along the column and two matching-edges of each plate are matching the previous and the next plates of the column and each of the plates includes:
   two rails, these rails are located longitudinally to both side-edges;
   two fixed-pines, each of the fixed-pines are installed perpendicular to the end of each side-edges; and
   two moveable-pines, each of the moveable-pines are installed perpendicular to each rail of the side-edge and able to move along the rail;
a plurality of connecting-shims, these connecting-shims are for connecting the plates of the column, wherein each of the plates is connected to the next plate by means of two connecting-shims each on each side-edge, wherein first side of the connecting-shim is pivotally joined to the fixed-pin of a plate and the other side of the connecting-shim is pivotally joined to the moveable-pin of the next plate;
a case, located beside the blocked end of the plates-string, enables the plates-string to be folded in and to be unfolded from; and
two guide-tracks each on each side of the plates-string, these guide-tracks are for bordering and guiding the plates-string while folding and unfolding, wherein the guide-tracks are open in the last section to enable the plates-string to be folded to the case and to be unfolded from.

By a preferred embodiment, it is provided a system of the present invention in a vertical position, further includes:
two flexible pulling means, such as a band or a cable, connected to each side-edge of the lowest plate of the system and enables to pull-up the lowest plate to fold the system; and
two drums or cylinders, located in the top of the system, wherein part of the flexible pulling means are rolled on the drums enabling pulling the flexible pulling means by rotating the drums.

By another preferred embodiment, it is provided a system of the present invention, in a vertical position, further includes:
at least one coil-spring installed in at least one of the drums, wherein the coil-spring is stretched when unfolding the system and provides helping force when folding the system.

By another preferred embodiment, it is provided a system of the present invention, in a vertical position, further includes:
a motor, this motor is connected to the drums and is used for rotating the drums in order to fold or unfold the system.

By another preferred embodiment, it is provided a system of the present invention, wherein the matching-edges of the plates are inclined-edges and the incline-edges enable the last blocked plate to be pushed aside by a previous plate.

By another preferred embodiment, it is provided a system of the present invention, wherein the moveable-pin has a mechanism operative for:
locking the movable-pin to the rail and prevents the moveable-pin movement, when the position of the connecting-shim is parallel along the edge of the connected-on plate; and
by releasing the locking mechanism and enables the moveable-pin movement, when the connecting-shim rotates to a predetermined angle in relation of said plate.

By another preferred embodiment, it is provided a system of the present invention, wherein at least part of the plates are windows' wings.

By another preferred embodiment, it is provided a system for the present invention, wherein at least part of said plates are shutters' slats.

By another aspect of the present invention, it is provided a window or a shutter, this window or shutter is made of wing-string capable to be folded by pushing the first wing of the wing-string while the last wing is blocked and capable to be unfolded by pulling the first wing of the wing-string while the last wing is blocked and wherein the window or shutter which is comprised of:
a plurality of wings arranged in a wings-string column, wherein two side-edges of each the wing are along the column and two matching-edges of each wing are matching the previous and the next wings of the column, each of the wings includes:
   two rails, these rails are located longitudinally to both side-edges;
two fixed-pines, each of the fixed-pines are installed perpendicularly on the end of each side-edges; and
two moveable-pines, each of moveable-pines are installed perpendicularly on each rail of the side-edge and able to move along the rail; and
a plurality of connecting-shims, these connecting-shims are for connecting the wings of the column, wherein each of wings are connected to the next wing by means of two connecting-shims each on each side-edge, wherein first side of the connecting-shim is pivotally joined to the fixed-pin of a wing and the other side of the connecting-shim is pivotally joined to the moveable-pin of the next wing.

By a preferred embodiment it is provided the window or the shutter of the present invention, further includes:
a case, located beside the blocked end of the wings-string, enables the wings-string to be folded in and to be unfolded from; and
two guide-tracks each in each side of the wings-string, these guide-tracks are for bordering and guiding the wings-string while folding and unfolding, wherein the guide-tracks are open in the last section to enable the wings-string to be folded to the case and to be unfolded from.

By another preferred embodiment it is provided the window or the shutter of the present invention, in a vertical position, further includes:
two flexible pulling means, such as a band or a cable, connected to each side-edges of the lowest wing of the window or shutter and enable to pull-up the lowest wing to fold the window or the shutter; and
two drums, located in the top of the window or shutter, wherein part of the flexible pulling means are rolled on the drums enabling pulling the flexible pulling means, by rotating the drums.

By another preferred embodiment it is provided the window or the shutter of the present invention, in a vertical position, further includes:
at least one coil-spring installed in at least one of the drums, wherein the coil-spring is stretched when unfolding the window or the shutter and provides a helping force when folding the window or the shutter.

By another preferred embodiment it is provided the window or the shutter of the present invention, in a vertical position, further includes:
a motor, this motor is connected to the drums and is used for rotating the drums in order of folding and unfolding the window or the shutter.

By another preferred embodiment it is provided the window or the shutter of the present invention, wherein the matching-edges are inclined-edges, these incline-edges enable the last blocked wing to be pushed aside by a previous wing.

By another preferred embodiment it is provided the window or the shutter of the present invention, wherein the moveable-pin has a mechanism operative for:
locking the movable-pin to the rail and prevents the moveable-pin movement, when the position of the connecting-shim is parallel along the edge of the connected-on wing; and
by releasing the locking mechanism which enables the moveable-pin movement, when the connecting-shim rotates to a predetermined angle in relation to the wing.

By another aspect of the present invention, it is provided a method for folding and unfolding wings of a window or a shutter, wherein each time two of the wings are taking place in a circulatory action, this circulatory action includes:
placing two wings, first wing on top of second wing, wherein matching edges of the wings are inclined;
installing rails on both sides of each wing;
installing a fixed-pin in the upper end of each side of each wing;
installing a movable-pin on each of rails, the moveable-pin is able to move along the rail;
connecting between wings by two connecting-shims, a connecting-shim in each side, wherein one side of the connecting-shim is pivotally connected to the fixed-pin of the second wing and the other side is pivotally connected to the movable-pin of the first wing;
preventing vertical movement of the first wing and pushing up the second wing, this pushes aside the lower part of the first wing;
continuing pushing up the second wing for slide the second wing along the first wing to straighten the first wing beside the second wing, while the connecting-shim drags the movable-pin up along the rail; and
for unfolding, pulling the second wing back.

The circulatory action can be done either vertically or horizontally.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the figures:

FIG. 1 illustrates a side view of an embodiment of the system and the folding of the system—step by step—when the matching-edges are inclined.

FIG. 2 illustrates a side view of the connecting-shims and a moveable-pin with a mechanism that enables an embodiment of the system with non-inclined matching-edges.

FIG. 3 illustrates an embodiment of the system as a window.

### DESCRIPTION OF THE PREFERED EMBODIMENTS

The present invention is a foldable plate-system. The system, according to the present invention, is useful as a window. In a preferred embodiment the system is in a vertical position and the plates are windows' wings.

When the system is unfolded, the window is closed. Several wings are placed one on top of other, wherein the highest wing is located beside a case where the wings can be folded in and wherein this wing is blocked from above. Preferably, there are tracks on both sides to border and guide the movement of the wings, these tracks are open in the case area and enable the wings to move aside into the case. Each wing is connected to the next wing by means of two shims—one in each side—wherein the slim is pivotally joined to a fixed pin of one wing and to a moveable-pin of the next wing. The movable-pins are installed on rails that are located along each side of the wings and the moveable-pin is able to move along the rail that it is installed on.

In a preferred embodiment, the match-edges of the wings are inclined. To open the window the lowest wing is pushed up, by hands or by any other mechanism, and a circulatory action is occurred to the two wings, which are the highest at that time. The wings are pushed up, the highest wing unable to move up but able to move aside into the case. Since the matching-edges are inclined, the bottom of the highest wing is pushed aside by the previous wing. The previous wing continues to move up—sliding along the highest wing while dragging the movable-pin along the rail and straightens the highest wing inside the case.

The previous wing became the highest wing and the mechanism is repeated and pushes the folded wings into the case. In the end, all the wings are folded inside the case and the window is open.

The principles and operation of the foldable plate-system, according to the present invention, may be better understood with reference to the drawing and the accompanying description.

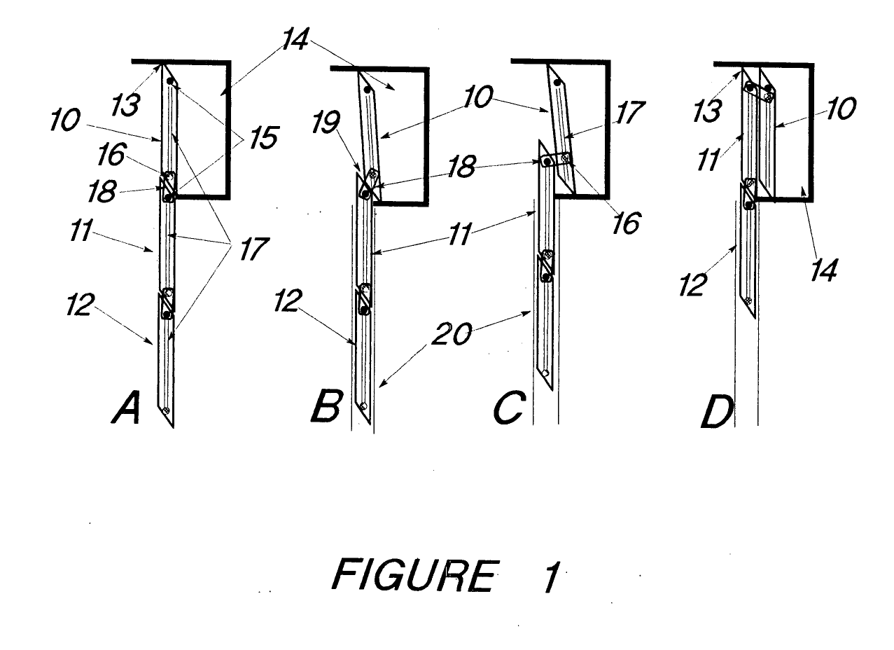

Referring now to the drawing, FIG. 1 illustrates a side view of an embodiment of the system and the folding of the system—step by step—when the matching-edges are inclined. The figure shows one side, and the other side of the system is built and operates in the same way. In the figure three plates of the system, in a vertical position, are shown. While the system is unfolded—FIG. 1-A—the plates, which are the first and highest plate 10, the second plate 11 and bottom plate 12, are placed one on top the other and while the first plate 10 is blocked 13 and a case 14 is located beside it. Each plate side has a fixed-pin 15 in the upper end, a movable-pin 16 and a rail 17 longitudinally that enables the movable-pin 16 to move along it. The plates are connected—each plate to the next one—by means of a shim 18. For example, the first plate 10 is connected to the second plate 11 by a shim 18 that is pivotally joined to the fixed-pin 15 of the second plate 11 and pivotally joined to the movable-pin 16 of the first plate 10. The second plate 11 is connected in the same way to the bottom plate 12.

In order to fold the system—FIG. 1-B—the bottom plate 12 is pushed up, which pushes all the plates up along the track 20. Since the first plate 10 cannot move up, the bottom of the first plate 10 is pushed aside—by the pushing force and the inclined edges 19—into the case 14.

Continually pushing—FIG. 1-C—leads the second plate 11 along the first plate 10 while the shim 18 drags the movable-pin 16 up along the rail 17. The elevation up of the second plate 11 straightens the first plate 10 inside the case 14.

In FIG. 1-D the second plate 11 arrives to the previous position of the first plate 10 and the two plates arranged side by side in the case 14. Now the second plate 11 is blocked 13 and the bottom plate 12 pushes the second plate 11 and the same mechanism is repeated to push and straighten the two previous plates 10 & 11 and finally all the plates are arranged side by side in the case 14, the system now is folded.

Pulling the bottom plate 12 down will reverse the actions back and unfold the system.

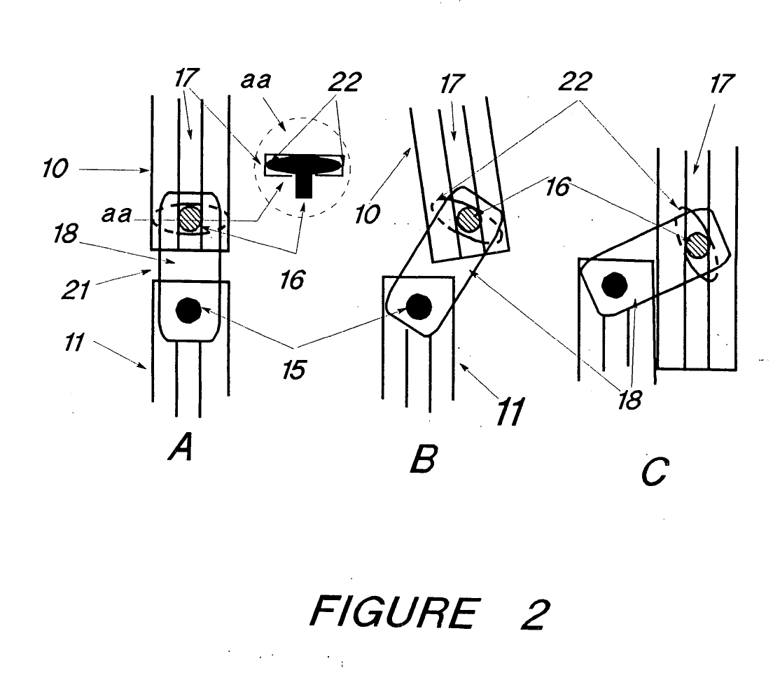

FIG. 2 illustrates a side view of the connecting-shims and a moveable-pin with an embodiment of the mechanism that enables the system with non-inclined matching-edges. In FIG. 2-A the shim 18 connects one plate 10 to other plate 1-1 with a space 21 between each to plates. The shim 18 is pivotally joined to the fixed-pin 15 of a plate 11 and to the movable-pin 16 of the next plate 10. The movable-pin 16 is located on a rail 17 with an elliptic base that has two far edges 22. A cross-section “aa” of the movable-pin 16 and the rail 17 shows the far edges of the movable-pin base 22 pushing the sides of the rail 17 and prevents movement the movable-pin. In this embodiment each plate pushes the next plate by the shims 18 while the moveable-pin 16 is blocked.

When the high plate 10 is blocked—FIG. 2-B—the pressure of the low plate 11 pushes the high plate 10 aside. The shim 18 turning the movable-pin 16 and the far edges 22 of the movable-pin base, releases the sides of the rail 17 and the movable-pin 16 is able to move up with the low plate 11, dragged by the shim 18. The low plate 11 slides along the high plate 10—FIG. 2-C.

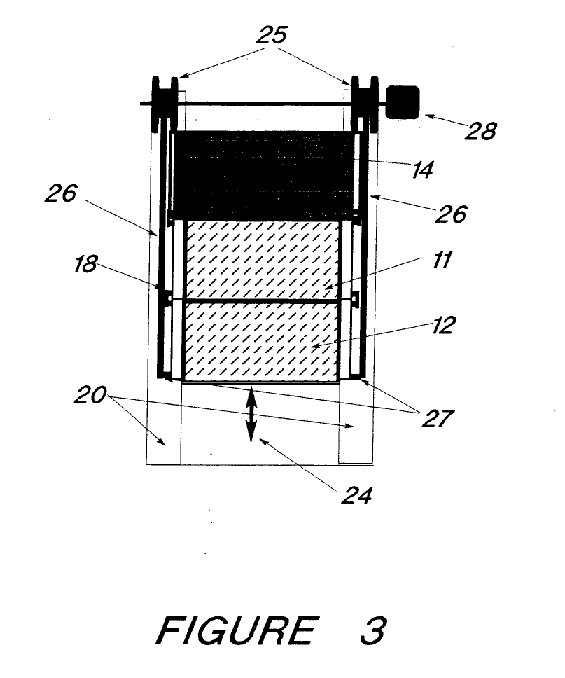

FIG. 3 illustrates an embodiment of the system as a window. The shown window has three wings, the first wing (not shown), the second wing 11 and the bottom wing 12. The wings are connected by shims 18 and bordered and guided by two tracks 20, one on each side. In order to open the window, the bottom wing 12 is pushed up 24. The whole wings are folded inside a case 14 according to the mechanism that previously described. In order to close the window the bottom wing 12 is pushed down 24.

In a preferred embodiment, two pulling-means 26—such cables, bands or any other flexible pulling means—are connected to the bottom wing 12, preferably by connection means 27. The pulling means 26 enable to pull up the bottom wing 12, mechanically. The pulling means 26 are partly rolled on two drums 25. The wings can be pulled up or released down by rotating the drums 25.

The drums 25 can have a coil spring or springs (not shown) that are stretched when closing the window down and provides a helping force when opening the window up.

By another preferred embodiment, a motor 28 can be installed in the window in order to rotate the drums 25 for electrical closing or opening of the window.

As used herein in the specification and in the claims section that follows, the term “plate” and the like refer to a plurality of plate kind, such as windows' wing, shutters' slates and any other kind of plates and the term “window” and the like refer also to a shutter, blind or shade and vice versa.

Although the invention has been described in conjunction with specific embodiments thereof, it is evident that many alternatives, modifications and variations will be apparent to those skilled in the art, accordingly, it is intended to embrace all such alternatives, modifications and variations that fall within the spirit and broad scope of the appended claims.

1. A system, said system is made of plates-string capable to be folded by pushing the first plate of said plates-string while the last plate is blocked and capable to be unfolded by pulling the first plate of said plates-string while the last plate is blocked, said system comprised of:
(a) a plurality of plates arranged in a plates-string column, wherein two side-edges of each said plate are along said column and two match-edges of each said plate are matching the previous and the next plates of the column, each of said plates includes:
(i) two rails, said rails are located longitudinally to both said side-edges;
(ii) two fixed-pines, each of said fixed-pines is installed perpendicular to the end of each said side-edges; and
(iii) two moveable-pines, each of said moveable-pines is installed perpendicular to each said rail of said side-edge and able to move along said rail; and
(b) a plurality of connecting-shims, said connecting-shims are for connecting said plates of said column, wherein each of said plates is connected to the next plate by means of two said connecting-shims each on each side-edge, wherein first side of said connecting-shim is pivotally joined to said fixed-pin of a plate and the other side of said connecting-shim is pivotally joined to said moveable-pin of the next plate.

2. The system of claim 1, further includes:
(c) a case, located beside the blocked end of said plates-string, enables said plates-string to be folded in and to be unfolded from; and
(d) two guide-tracks each in each side of said plates-string, said guide-tracks are for bordering and guiding said plates-string while folding and unfolding, wherein said guide-tracks are open in the last section to enable said plates-string to be folded to said case and to be unfolded from.

3. The system of claim 1, in a vertical position, further includes:
(e) two flexible pulling means, such as a band or a cable, connected to each side-edges of the lowest plate of said system and enables to pull-up said lowest plate to fold said system; and
(f) two drums, located in the top of said system, wherein part of said flexible pulling means are rolled on said drums enabling pulling said flexible pulling means by rotating said drums.

4. The system of claim 3, further includes:
(h) at least one coil-spring installed in at least one of said drums, wherein said coil-spring is stretched when unfolding said system and provides helping force when folding said system.

5. The system of claim 3, further includes:
(i) a motor, said motor is connected to said drums and is used for rotating said drums in order to fold or unfold said system.

6. The system of claim 1, wherein said match-edges are inclined-edges, said incline-edges enable said last blocked plate to be pushed aside by a previous plate.

7. The system of claim 1, wherein said moveable-pin has a mechanism operative for:
(a) locking said movable-pin to said rail and prevents said moveable-pin movement, when the position of said connecting-shim is parallel along the edge of the connected-on plate; and
(b) by releasing said locking and enables said moveable-pin movement, when said connecting-shim rotates to a predetermined angle in relation to said plate.

8. The system of claim 1, wherein at least part of said plates are windows' wings.

9. The system of claim 1, wherein at least part of said plates are shutters' slats.

10. a window or a shutter, said window or shutter is made of wing-string capable to be folded by pushing the first wing of said wing-string while the last wing is blocked and capable to be unfolded by pulling the first wing of said wing-string while the last wing is blocked, said window or shutter comprised of:
(a) a plurality of wings arranged in a wings-string column, wherein two side-edges of each said wing are along said column and two match-edges of each said wing are matching the previous and the next wings of the column, each of said wings includes:
(i) two rails, said rails are located longitudinally to both said side-edges;
(ii) two fixed-pines, each of said fixed-pines is installed perpendicularly on the end of each said side-edges; and
(iii) two moveable-pines, each of said moveable-pines is installed perpendicularly on each said rail of said side-edge and able to move along said rail; and
(b) a plurality of connecting-shims, said connecting-shims are for connecting said wings of said column, wherein each of said wings is connected to the next wing by means of two said connecting-shims each on each side-edge, wherein first side of said connecting-shim is pivotally joined to said fixed-pin of a wing and the other side of said connecting-shim is pivotally joined to said moveable-pin of the next wing.

11. The window or the shutter of claim 10, further includes:
(c) a case, located beside the blocked end of said wings-string, enables said wings-string to be folded in and to be unfolded from; and
(d) two guide-tracks each in each side of said wings-string, said guide-tracks are for bordering and guiding said wings-string while folding and unfolding, wherein said guide-tracks are open in the last section to enable said wings-string to be folded to said case and to be unfolded from.

12. The window or the shutter of claim 10, in a vertical position, further includes:
(e) two flexible pulling means, such as a band or a cable, connected to each side-edges of the lowest wing of said window or shutter and enable to pull-up said lowest wing to fold said window or said shutter; and
(f) two drums, located in the top of said window or shutter, wherein part of said flexible pulling means are rolled on said drums enabling pulling said flexible pulling means, by rotating said drums.

13. The window or the shutter of claim 12, further includes:
(h) at least one coil-spring installed in at least one of said drums, wherein said coil-spring is stretched when unfolding said window or said shutter and provides helping force when folding said window or said shutter.

14. The window or the shutter of claim 12, further includes:
(i) a motor, said motor is connected to said drums and is used for rotating said drums in order to fold or unfold said window or said shutter.

15. The window or the shutter of claim 10, wherein said match-edges are inclined-edges, said incline-edges enable said last blocked wing to be pushed aside by a previous wing.

16. The window or the shutter of claim 10, wherein said moveable-pin has a mechanism operative for:
(a) locking said movable-pin to said rail and prevents said moveable-pin movement, when the position of said connecting-shim is parallel along the edge of the connected-on wing; and
(b) by release of said locking and enables said moveable-pin movement, when said connecting-shim rotates to a predetermined angle.

17. A method for folding and unfolding wings of a window or a shutter, wherein each time two of the wings are taking place in a circulatory action, said circulatory action includes:
(a) placing two wings, first wing on top of second wing, wherein matching edges of said wings are inclined;
(b) installing rails on both sides of each wing;
(c) installing a fixed-pin in the upper end of each side of each wing;
(d) installing a movable-pin on each said rails, said moveable-pin able to move along the rail;
(e) connecting between wings by two connecting-shims, a connecting-shim in each side, wherein one said of the connecting-shim is pivotally connected to the fixed-pin of the second wing and the other side is pivotally connected to said movable-pin of said first wing;
(f) preventing vertical movement of said first wing and pushing up said second wing to push aside the lower part of said first wing;
(g) continuing pushing up said second wing for slide said second wing along said first wing to straighten said first wing beside said second wing, while said connecting-shim drags said movable-pin up along said rail; and
(h) for unfolding, pulling said second wing back.

18. The method of claim 17, wherein said circulatory action is done horizontally.
